(19) United States
(12) Patent Application Publication
(10) Pub. No.: US 2026/0102840 A1
(43) Pub. Date: Apr. 16, 2026

(54) ELECTRODE CAP MAGAZINE LOADING DEVICE

(71) Applicant: Daniel Chandler Harrison, Gray Court, SC (US)

(72) Inventor: Daniel Chandler Harrison, Gray Court, SC (US)

(21) Appl. No.: 18/914,780

(22) Filed: Oct. 14, 2024

(51) Int. Cl. B23K 11/30

(52) U.S. Cl. CPC B23K 11/3072

(57) ABSTRACT

An electrode cap magazine loading device and method of use are provided. The electrode cap loading device can have a body including at least one port to access an electrode cap guide tube configure to install an electrode cap into a magazine. A plunger can be partially disposed within the body and can include an actuation mechanism, such as a spring. A user can insert an electrode cap into the device through the at least one port causing the cap to reside in the electrode cap guide tube. The user can depress the plunger thereby forcing the electrode cap into the magazine.

### BACKGROUND OF THE INVENTION

### Field of Invention

The present disclosure relates to welding devices and loading thereof, and more particularly, to a hand-powered loading device for a welder configured to load electrode cap magazines quickly and efficiently.

### Background of Related Art

In manufacturing assembly lines, it is often most efficient to join metallic components with spot welds, utilizing resistance welding techniques. These welding techniques are performed in an automated manner by one or more machines having moveable, and/or disposable parts. Resistance welding requires the flow of electrical current through one or more electrode caps to adjoining pieces of metal, such that the pieces of metal are fused together. The passage of current through the one or more electrode caps causes rapid deterioration requiring constant replacement of the one or more electrode caps. Traditionally, an electrode cap magazine is provided to house a plurality of electrode caps for use by the one or more machines, however, loading of the magazine is time-consuming, and physically strenuous, requiring large amounts of force to be applied by the hand of a user to insert each electrode cap.

Prior art mechanism for loading electrode cap magazines, such as U.S. Pat. No. 9,486,876 provide automated mechanisms for loading electrode caps. However, the system of the '876 patent is automated, requiring power for sensors and actuators, which are subject to failure and downtime. Additionally, systems like the '876 patent are complex machines that are costly to repair and/or replace, and maintain.

As can be seen there is a need for an electrode cap magazine loading tool that is hand powered, and is designed to reduce manual loading time, and resulting physical stressed associated with manual loading.

### BRIEF SUMMARY OF THE INVENTION

In one aspect of the present disclosure, one aspect of the present disclosure, an electrode cap magazine loading device is provided. The electrode cap magazine loading device can include a body having at least one electrode cap guide tubes configured guide at least one electrode cap into a magazine, at least one of plunger guide, and at least one electrode cap installation port configured to accept the at least one electrode cap into one of the at least one electrode cap guide tubes. A plunger can be, at least partially, disposed within the body and can have a head, at least one guidepost affixed to the head, wherein each guidepost is disposed in a different one of the at least one plunger guides, and at least one plunger rods affixed to the head, wherein each plunger rod is disposed in a different one of the at least one of electrode cap guide tubes. An actuation mechanism, such as a spring, can be disposed within each of the at least one plunger guide, such that application of force from a user can compress the actuation mechanism, while removal of force can cause the plunger to return to a default position. At least one alignment tube can configured to accept a portion of the magazine and can include a securing mechanism configured to secure the body to the magazine.

In another aspect of the present disclosure, a method of using the electrode cap magazine loader is provided. A user can install the loader device on an electrode cap magazine by placing a portion of the magazine in each of the at least one alignment tubes, thereby causing at least one latch to be at least partially disposed within at least one latch aperture, and causing alignment of the at least one electrode cap guide tube with the magazine. Additionally, the magazine can be secured to the loader by installing each of a plurality of pins into a differing pin holder in the body of the loader. Once secured, a user can insert at least one electrode cap into an electrode cap guide tube utilizing a port on the body. Once the electrode cap is inserted, the user can apply force to the plunger which forces the electrode cap into the magazine. As force is release by the user the plunger can return to a default position where the process can be repeated.

### BRIEF DESCRIPTION OF THE DRAWINGS

FIG. 1 is a front perspective view of an embodiment of an electrode cap magazine loading device, according to aspects of the present invention;

FIG. 2 is an exploded view of an embodiment of an electrode cap magazine loading device, according to aspects of the present invention;

FIG. 3 is a perspective view of an embodiment of an electrode cap magazine loading device show in-use, according to aspects of the present invention;

FIG. 4 is a perspective view of an embodiment of an electrode cap magazine loading device show in-use, according to aspects of the present invention;

FIG. 5 is a bottom plan view of an embodiments of an electrode cap magazine loading device, according to aspects of the present invention; and

FIG. 6 is a cross-sectional view of an electrode cap magazine loading device taken along line 6-6 of FIG. 5, according to aspects of the present invention.

### DETAILED DESCRIPTION OF THE INVENTION

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Manual loading of electrode cap magazines for resistance welders is time consuming, inefficient, and physically strenuous. Prior art devices for loading electrode cap magazines rely on complicated components such as sensors and actuators that are themselves subject to wear and tear, and eventual breakdown, causing lost time.

Broadly, an embodiment of the present disclosure provides a hand-powered electrode cap magazine loader. The magazine loader of the present invention comprises at least a main body, and a plunger mechanism. The main body can include a first plurality of apertures configured to accept at least one electrode cap for loading into an electrode cap magazine. The plunger mechanism can include at least one plunger body and a plurality of actuators, such as springs. The plunger mechanism can be installed on the main body and can be configured to push the at least one electrode cap from the main body into the electrode cap magazine. The hand-powered electrode cap magazine can be manufactured by machining, 3D printing, and/or any manufacturing technique known in the art.

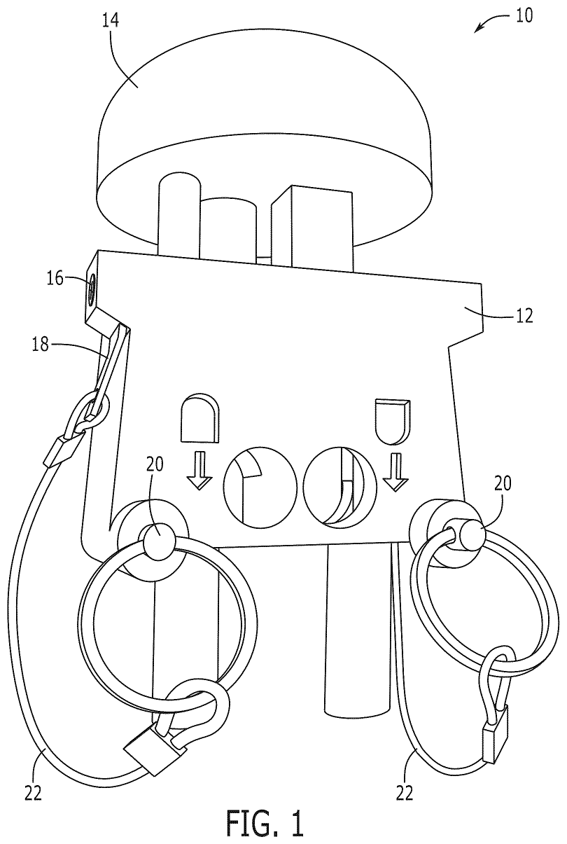

For purposes of the present description, the terms “upper,” “lower,” “left,” “rear,” “right,” “front,” “vertical,” “horizontal,” and derivatives thereof, shall relate to the apparatus as oriented in FIG. 1. It is also to be understood that the specific device and/or processes illustrated in the attached drawings, and described in the following specification, exemplify the subject matter without limiting the inventive aspects defined in the appended claims. For example, specific dimensions and other physical characteristics relating to the embodiments disclosed herein are not to be considered as limiting, unless the claims expressly state otherwise. Similarly, the claims are not limited by any expressed or implied theory of operation presented herein, if any.

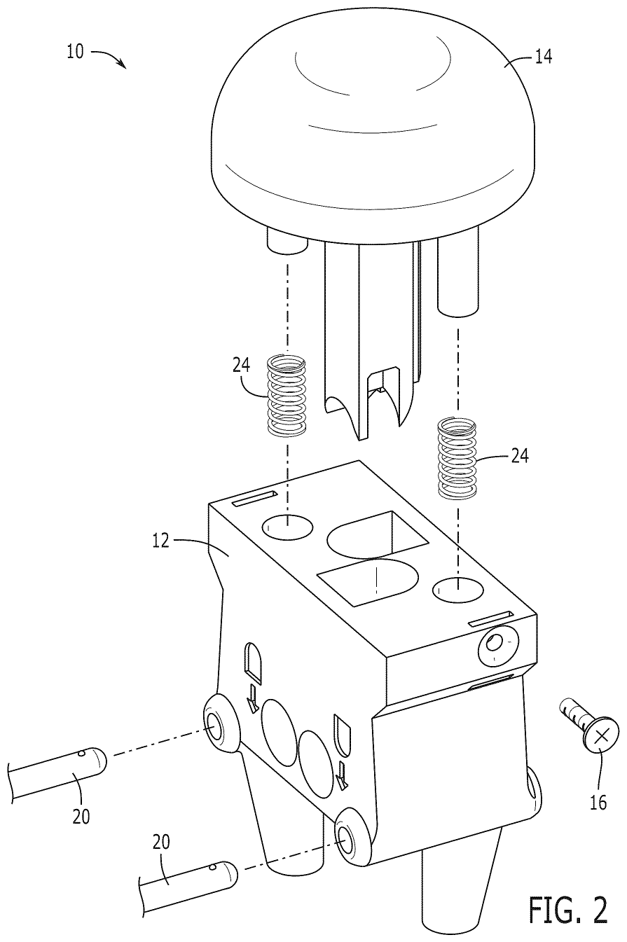

Referring now to FIGS. 1-2, aspects of the hand-powered electrode cap magazine loader device 10 are illustrated. FIG. 1 illustrates loader device 10 including a plurality of components such as a main body 12, plunger 14, at least one fastener 16, at least one tab 18, at least one retention cord 22 and at least one pin 20. In embodiments, loader device 10 includes a body 12 configured to receive at least one electrode cap into at least one electrode guide tube through at least one opening, or port, in the body. Additionally, the at least one electrode guide tube can align plunger 14 with the at least one electrode cap such that plunger 14 can apply force to the at least one electrode cap. Plunger 14 can be movably disposed within at least a portion of body 12 and can be configured to apply an installation force, when actuated by a user, to the at least one electrode cap disposed within body 12. At least one pin 20 can be disposed through at least one hole in body 12, and can be secured against loss by attachment to a first end of at least one retention cord 22 having a second end affixed to at least one tab 18, the at least one tab 18 being secured to a shoulder of body 12 by at least one fastener 16. In embodiments, loader device 10 can be machined, printed, molded, or otherwise manufactured from rigid, or semi-rigid materials, such metals, wood, plastics, etc. In embodiments, body 12 can have a length of approximately 88 millimeters (mm), a width of approximately 43 mm, and a height of approximately 95 mm.

FIG. 2 illustrates an exploded view of loader device 10. Body 12 can be monolithically formed, or otherwise manufactured, to include a plurality of surfaces, recessed portions, apertures, ports, and components, configured to assist in the overall functionality of loader device 10. In embodiments, body 12 can include at least one electrode cap guide tube (unlabeled) having a first opening on a top surface of body 12 and a second opening on a bottom surface of body 12 and having a negative space therebetween configured to receive at least one electrode cap for installation through at least one port (unlabeled) on a front surface of body 12, and to guide plunger 14 during operation. Additionally, the top surface can include at least one plunger guide(s) (unlabeled) disposed thereon. In embodiments, the at least one of plunger guide(s) can each define a recessed portion of body 12 configured to receive a spring 24 and a portion of plunger 14.

Body 12 can include at least one pin holder(s) (unlabeled) defining cylindrical, or tubular, holes disposed from a front surface of body 12 through to a back surface of body 12 and each configured to receive pin 20. Body 12 can include at least one shoulder on each of a right-side surface and a left-side surface of body 12, each of which having an aperture therethrough configured to receive a tab 18. Additionally, each shoulder can include an aperture configured to receive a fastener 16 for securing tab 18 to body 12.

Body 12 can have at least one alignment tube(s) (unlabeled) configured to receive a portion of electrode cap magazine 26A such that when the portion of the magazine is seated therein loader device 10 is in alignment with electrode cap magazine. In embodiments, the at least one alignment tubes are continuously formed to a bottom surface 10 and include cylindrical, or tubular, apertures or holes configured to receive a portion of an electrode cap magazine.

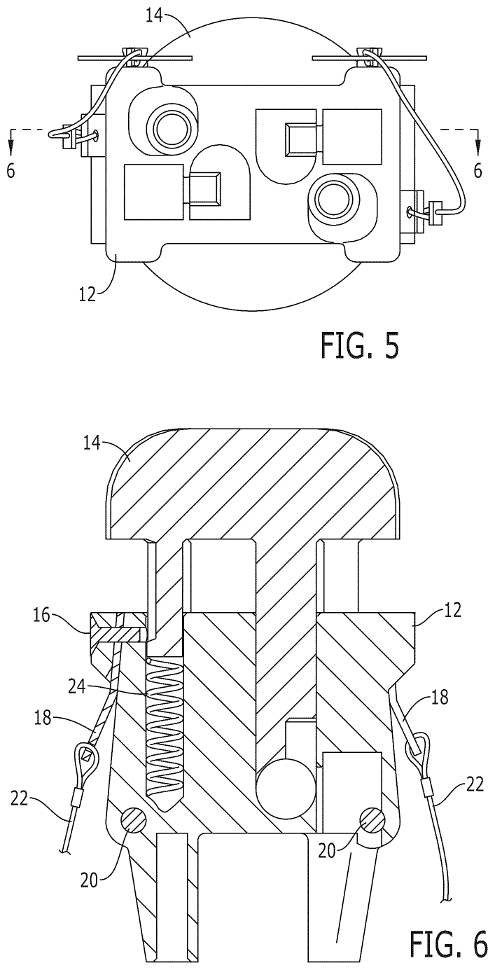

Plunger 14 can be continuously, or monolithically, formed to include a head, at least one plunger rod, and at least one guidepost(s). Head of plunger 14 is configured to transfer force applied by a hand of a user to at least one electrode cap disposed within the at last one electrode cap guide tube through the at least one plunger rod. In embodiments, the head of plunger 14 can include curvatures, for ergonomic considerations, but is not so limited. In embodiments, the at least one plunger rod can include an electrode interface disposed on an end of plunger rod distal from an interface between plunger rod and head. In embodiments, the electrode interface can be formed or shaped, in a curved manner, to distribute force from plunger 14 to at least one electrode cap during actuation, and can include a recessed portion (as illustrated in FIGS. 5-6). Each of the at least one guideposts can be monolithically formed as cylinders, but other shapes are contemplated. In embodiments, each of the at least one guideposts are shape to fit, at least partially, within one of the plunger guides. In embodiments, a spring 24 is placed within the recessed portion of each of the plunger guides, and each of the guideposts are inserted within a different one of the plunger guides. In embodiments, head of plunger 14 can have a diameter of approximately 80 mm, guideposts can have a length of approximately 33 mm, and plunger rod can have a length of approximately 48 mm. Advantageously, each of springs 24 allow plunger 14 to return to an uncompressed position as a force from a user is released.

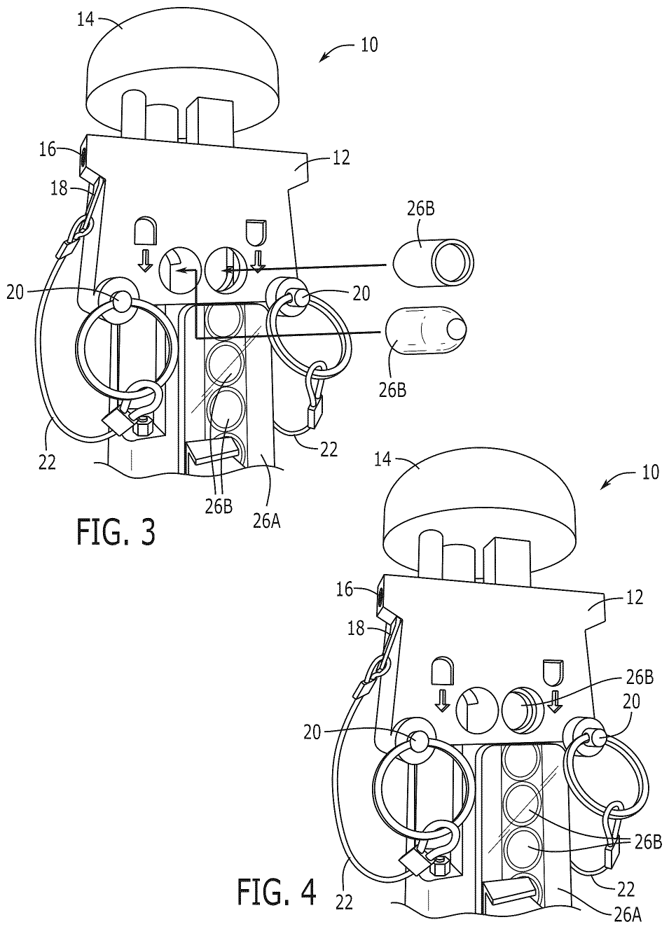

Referring now to FIGS. 3-4, aspects of operation and usage of loader device 10 are illustrated. In embodiments, loader device 10 can be installed on electrode cap magazine 26A (as illustrated in FIG. 3). In embodiments, the at least one alignment tubes (unlabeled) are each disposed over portion(s) of electrode cap magazine 26A. Once the at least one alignment tubes are disposed over portion(s) of electrode cap magazine 26A, each of pins 20 can be inserted into differing ones of the in holders, thereby securing electrode cap magazine 26A to loader device 10, described further with reference to FIGS. 5-6. Advantageously, utilization of pins 20 prevents electrode cap magazine 26A from moving, or becoming dislodged, during usage.

At least one electrode cap 26B can be inserted into loader device 10 utilizing one or more apertures, or ports, on a front surface of body 12. In embodiments, the one or more apertures, or ports, on a front surface of body 12 can allow insertion of at least one electrode cap 26B into electrode cap guide tubes (as illustrated in FIG. 3). Once at least one electrode cap 26B is inserted into at least one electrode cap guide tube (as illustrated in FIG. 4), a user can depress plunger 14 forcing at least one electrode cap 26B into electrode cap magazine 26A. In embodiments, at least one latch of the electrode cap magazine 26A can be disposed within body 12 and configured to secure at least one electrode cap 26B therein.

Referring now to FIGS. 5-6, additional aspects of the hand-powered electrode cap magazine loader device 10 are illustrated. FIG. 5 illustrates a bottom view of body 12 of loader device 10. In embodiments, body 12 can include at least one electrode cap guide tube (unlabeled) having a first opening on a top surface of body 12 and a second opening on a bottom surface of body 12 and having a negative space therebetween configured to receive at least one electrode cap for installation, and to guide plunger 14 during operation. In embodiments, there are at least two electrode guide tubes, each being shaped such that every electrode cap disposed therein is oriented differently from each electrode cap disposed in the other of the electrode guide tubes. In embodiments, each of the at least one electrode cap guide tubes can have a latch aperture (aperture) connected thereto, which can define a substantially rectangularly prismatic, or cuboid, negative space (as illustrated in FIG. 6). In embodiments, each of the latch apertures can allow for movement of the at least one latch of the electrode cap magazine 26A during installation of the at least one electrode cap 26B. In embodiments, each of the at least one alignment tubes (unlabeled) are disposed proximate to one of the at least one electrode guide tubes, and include an inner wall with sufficient inner diameter to accept a mount of electrode cap magazine 26A (as illustrated in FIG. 6).

FIG. 6 illustrates a cross-sectional view of loader device 10. At least one plunger rod (unlabeled) and at least one guidepost (unlabeled) of plunger 14 are shown within at least one electrode cap guide tube (unlabeled) and at least one plunger guide (unlabeled). In embodiments, each of the at least one plunger rods are disposed within a different one of at least one electrode cap guides, and can be actuated therein, by user applied force, to insert at least one electrode cap 26B into electrode cap magazine 26A. Additionally, in embodiments the recessed portion of the electrode interface of each plunger rod is configured to allow movement of the at least one latch of the electrode cap magazine 26A. In embodiments, actuation is aided by spring 24 disposed within each of the at least one plunger guides, such that each of the at least one guideposts is in contact therewith. In embodiments, force applied to plunger 14, by a user, causes spring 24 to compress, such that, as force applied by the user dissipates, spring 24 uncompresses thereby returning plunger 14 to its initial position.

To use loader device 10, a user can first install loader device 10 onto electrode cap magazine 26A, utilizing the plurality of alignment tubes and the at least one latch aperture, and securing thereto utilizing by installing at least one pins 20 into the at least one pin holders. In embodiments, tubular portions of electrode cap magazine 26A are at least partially disposed within each of the plurality of alignment tubes, such that at least one latch of the electrode cap magazine 26A is housed within at least one latch aperture, and the at least one electrode guide cap is in alignment with electrode cap magazine 26A.

Once secured, a user can insert at least one electrode cap 26B into one or more of the openings, or ports in body 12. In embodiments, each opening, or port, provides access to one of the plurality of electrode cap guide tubes. Once inserted, a user can apply force to plunger 14 thereby forcing the at least one electrode cap 26B into electrode cap magazine 26A. In embodiments, as the at least one electrode cap 26B is forced into electrode cap magazine 26A it can displace the at least one latch into the latch aperture. As force applied by the user is released, plunger can return to its default position, wherein the at least one latch can return and seat over the at least one electrode cap 26B thereby securing cap 26B in magazine 26A. Once plunger 14 returns to a default position the loading process can repeat, as needed.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed:

1. An electrode cap magazine loading device, comprising:
a body, comprising:
at least one electrode cap guide tube configured guide at least one electrode cap into a magazine;
at least one plunger guides; and
at least one electrode cap installation ports configured to accept the at least one electrode cap into one of the at least one electrode cap guide tube;
a plunger, comprising:
a head;
at least one guidepost affixed to the head;
at least one plunger rod affixed to the head;
an actuation mechanism disposed within each of the at least one plunger guide;
at least one latch aperture configured to accept at least one latch of the magazine; and
a securing mechanism configured to secure the body to the magazine.

2. The electrode cap magazine loading device of claim 1, wherein the actuation mechanism is a spring.

3. The electrode cap magazine loading device of claim 1, wherein the securing mechanism includes:
at least one tubular port disposed through the body; and
at least one pin insertable into each of the at least one tubular port.

4. The electrode cap magazine loading device of claim 3, further comprising:
at least one tab partially disposed within the body and secured to the body by a fastener;
at least one retention cord affixed at a first end to the at least one tab and affixed at a second end to a ring, wherein the ring is disposed through one or the plurality of pins.

5. The electrode cap loader device of claim 1, the at least one plunger rod, having:
a first end continuously formed to a surface of the head of the plunger; and
a second end having an electrode interface continuously formed thereto.

6. The electrode cap loader device of claim 5, the electrode interface, having:
a shoulder portion; and
a protrusion extending from the shoulder portion, the protrusion having an arcuate end.

7. The electrode cap loader device of claim 6, wherein the shoulder portion is configured to allow actuation of the at least one latch of the magazine.
